(19) United States
(12) Patent Application Publication
(10) Pub. No.: US 2005/0186125 A1
(43) Pub. Date: Aug. 25, 2005

(54) Treatment apparatus

(76) Inventors: Hiromitsu Matsuno, Tokyo (JP); Taku Sumitomo, Hyogo (JP); Nobuyuki Hishinuma, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/060,619

(22) Filed: Feb. 18, 2005

(30) Foreign Application Priority Data
Feb. 19, 2004 (JP) 2004-043391

(51) Int. Cl. A62B 7/08; B32B 5/02

(52) U.S. Cl. 422/121; 422/122

(57) ABSTRACT

According to the present invention, in a treatment apparatus, catalyst is used in order to dissolve molecular gas containing hydrogen atoms or oxygen atoms, and an object is treated by gas produced by the catalyst. The treatment apparatus comprises a catalyst irradiation unit, wherein the catalyst is irradiated, by the catalyst irradiation unit, with light having a wave number larger than work function of the catalyst expressed in wave number.

### FIELD OF THE INVENTION

The present invention relates to a treatment apparatus for treating objects by cracking a gas in the presence of a catalyst. More specifically, optical energy is used in the treatment process of treating the objects by cracking the gas with the catalyst.

### DESCRIPTION OF THE RELATED ART

In order to remove organic substances during a process of manufacturing semiconductors or cleaning liquid crystal substrates, some methods have recently been developed, in which high-melting-point catalysts to ash or remove resists is used. For example, Japanese Laid Open Patent No. 2002-289586 has disclosed one of the methods. In this method, a high-melting-point metal, such as tungsten, is heated to be used as the high-melting-point catalyst, and a gas containing hydrogen atoms is allowed to react to produce atomic hydrogen by catalytic cracking in the presence of the catalyst. By bringing the atomic hydrogen into contact with a resist, the resist is removed.

FIG. 8 shows a known treatment apparatus using a catalyst. The treatment apparatus 80 includes a reaction chamber 82 enclosed by an external wall. The reaction chamber 82 contains a high-melting-point metal catalyst 100, such as tungsten. The catalyst 100 is connected to a power source 85 for energizing the catalyst 100 to heat. The reaction chamber 82 also contains a stage 88 on which an object 89 to be treated is placed. The external wall defining the reaction chamber 82 is provided with a gas inlet 86a through which a reactive gas containing hydrogen atoms is introduced and an outlet 86b from which the gas is let out after reaction. For example, if hydrogen is introduced through the inlet 86a, the hydrogen comes into collision with the catalyst made of tungsten in the reaction chamber 82 and, at this point, the hydrogen is adsorbed on the surface of the tungsten. Then, the hydrogen molecules (H₂) are cracked into hydrogen atoms (H) by a reaction referred to as adsorption and dissociation. The hydrogen atoms (H) are combined with tungsten atoms (W) to form W—H on the surface of the tungsten. Subsequently, the tungsten which is catalyst is heated to about 1,700° C. by energization so that the W—H bond is cut by heat energy, and the resulting activated H separates from the surface of the tungsten. Thus, a clean face is formed again on the surface of this tungsten from which the hydrogen atoms have been separated. The clean tungsten surface is repeatedly brought into collision with hydrogen molecules, and the same reaction as described above is repeated. Thus, high-concentration activated hydrogen is produced in the reaction chamber 82. The active hydrogen is brought into contact with the object to be treated. Thus, in the above-described publication, atomic hydrogen is brought into contact with a resist to be removed.

The extended abstracts No. 2 of the 50th Workshop of Japan Society of Applied Physics and Related Societies, p. 844 (March, 2003) discloses another method using heated tungsten as the high-melting-point catalyst. In this method, ammonia is brought into contact with the tungsten to produce cracked ammonia, and the cracked ammonia is allowed to act on a resist to remove.

Japanese Journal of Applied Physics, Vol. 41 (2002), pp. 4639-4641 discloses another method in which H₂ is brought into contact with heated tungsten to produce H, and the H is allowed to act on Si to carry out etching.

As described above, it is proposed that metal such as tungsten is used as the high-temperature-catalyst. It is considered that such an activated species is produced through the following mechanism. If a reactive gas, such as that of hydrogen molecules, comes into collision with the surface of a metal, the hydrogen molecules adsorb on the surface of the metal. At this point, the metal, such as tungsten, serves as a catalyst to produce a combined species of hydrogen atoms with the metal, for example, tungsten on the metal surface. Then, the tungsten is heated to, for example, 1,700° C. or more (a surface temperature) so that the hydrogen atoms separate from the surface of the tungsten by the heat energy. Thus, highly reactive hydrogen atoms are produced. By the thermal separation of hydrogen atoms, the surface of the tungsten is returned to a clean metal state in which dissociation and adsorption can be repeated by collision of hydrogen molecules with the metal. Thus, the catalytic reaction is continued.

Unfortunately, the metal serving as the high-melting-point catalyst is inevitably vaporized in the above-described methods because those methods involve thermal separation by heating the metal. The vaporized metal undesirably contaminates the object to be treated.

### SUMMARY OF THE INVENTION

In view of the above-described disadvantages, the inventors of the present invention have conducted intensive research, and found that a highly reactive species of, for example, hydrogen can be separated from a catalyst by irradiating with light an element dissociated through adsorption by the catalyst.

The present invention is based on this finding, and the object of the present invention is to provide a treatment apparatus which produces a highly efficient activated species of a substance without contaminating objects to be treated and which, thus, treats the object at a high speed.

In a treatment apparatus according to the present invention, catalyst is used in order to dissolve molecular gas containing hydrogen atoms or oxygen atoms, and an object is treated by gas produced by the catalyst, comprises a catalyst irradiation unit, wherein the catalyst is irradiated, by the catalyst irradiation unit, with light having a wave number larger than work function of the catalyst expressed in wave number.

The work function refers to energy required to increase the potential of electrons confined in a substance to a potential over the bandgap, and is generally expressed as a potential difference in electron volt (eV). While light emitted from a substance is generally expressed as a wavelength (nm), it may be expressed as the reciprocal of the wavelength, namely, wave number in kayser (cm⁻¹), to represent the electromagnetic energy of the light. The relationship is expressed by: Energy (E)=Planck Constant (h)×Light Velocity (c)/Wavelength (λ). An energy expressed in electron volt (eV) can be converted to be expressed in kayser (cm⁻¹), that is, 1 eV=0.8066×10⁴ cm⁻¹. In the description herein, the emission of light having energy of more than a work function energy is described in a unified manner using a unit of energy, kayser (cm⁻¹).

The treatment apparatus of the present invention may further include an object irradiation unit for irradiating an object with light having a wave number of more than the work function expressed in wave number of the catalyst.

Preferably, the wave number of the light is more than 5.08×10⁴ cm⁻¹.

The light may be Ar₂ excimer light with a peak at a wave number of 7.934×10⁴ cm⁻¹.

The treatment apparatus may further include light emitting unit in which the Ar₂ excimer light is emitted by dielectric barrier discharge using Ar as a discharge gas, and the discharge gas contains hydrogen atoms or oxygen atoms.

Alternatively, the light emitting unit may be a Xe₂ excimer lamp with a peak at wave number of 5.81×10⁴ cm⁻¹ or a Kr₂ excimer lamp with a peak at a wave number of 6.85×10⁴ cm⁻¹.

The catalyst may be selected from the group consisting of Pt, Rh, Pd, Ir, Ru, Re, and Au.

The cracked gas may be jetted onto the object.

In another form of the treatment apparatus according to the present invention, a molecular gas containing hydrogen atoms is dissociated in the presence of a catalyst, and the cracked gas treat an object.

The treatment apparatus may include irradiation means for irradiating the catalyst and the object with light having a wave number of more than the work function of the catalyst expressed in wave number. The light has a wave number of 6.67×10⁴ cm⁻¹ or more, and SiO₂ is etched.

The treatment apparatus may further include a dielectric barrier discharge lamp emitting Kr₂ excimer light with a peak at a wave number of 6.85×10⁴ cm⁻¹ or Ar₂ excimer light with a peak at a wave number of 7.934×10⁴ cm⁻¹, and etches SiO₂.

The treatment apparatus of the present invention irradiates a catalyst for cracking a gas containing hydrogen atoms or oxygen atoms with light having a wave number of more than work function of the catalyst expressed in wave number, thus facilitating the separation of the cracked product adsorbed and dissociated on the catalyst by the contact of the gas with the catalyst. For example, if ammonia (NH₃) is used as the gas containing hydrogen atoms, the NH₃ gas comes into collision with the catalyst, for example, tungsten (W), to adsorb on the catalyst. Then, the NH₃ reacts with the W so that the NH₃ is cracked and W—H is formed, in a manner known as adsorption and dissociation. As for the N atoms, some of the N atoms may combine with the tungsten, but many of the N atoms combine with each other to form nitrogen gas (N₂) and are thus suspended in the air. The W—H produced by the adsorption and dissociation of NH₃ is irradiated with light having energy of more than the work function of the catalyst tungsten, so that the bond of the W—H is broken, and thus activated H separates from the tungsten. By heating the tungsten by, for example, energization during irradiation, the separation can be further promoted. Consequently, an activated product can be produced without heating the catalyst tungsten, or simply by supplemental heating. Thus, the vaporization of the catalyst can be reduced and the object can be prevented from being contaminated with the vaporized catalyst.

The object may be irradiated with the light having a wave number of more than the work function of the catalyst expressed in wave number. Thus, the bonds of the organic substances and resist on the object, such as C—C and C—H, can be broken, in addition to producing high-concentration activated species in the presence of the catalyst. Consequently, for example, an ion-implanted resist, which is hard to decompose, can be removed, and the speed in removing the organic substances and resist can be increased.

The wave number of the light may be 5.08×10⁴ cm⁻¹. By applying the light onto the object, not only single bonds of the organic substances and resist on the object, such as C—C and C—H, but also double bonds, such as C═C and O═O, can be broken. Consequently, the speed in removing difficult-to-decompose resists, such as ion-implanted resists, can be increased, and the organic substances and resists can be removed at a higher rate.

The light may be Ar₂ excimer light with a peak at a wave number of 7.934×10⁴ cm⁻¹. Since such light can break the C═O bond, triple bonds of C, N, and C and N, the speed in removing difficult-to-decompose resists, such as ion-implanted resists, can be increased, and the organic substances and resists can be removed at a higher rate.

The Ar₂ excimer light may be emitted by dielectric barrier discharge using Ar as the discharge gas. The discharge gas may contain the molecular gas containing hydrogen atoms or oxygen atoms. Thus, the excimer light having a wave number of 7.934×10⁴ cm⁻¹ generated by Ar gas dielectric barrier discharge can be efficiently applied to the molecular gas containing hydrogen atoms or oxygen atoms to produce activated O or H. In this instance, the dielectric barrier discharge itself changes part of the molecular gas into activated H or O. Thus, the activated species H or O can be produced in a high concentration, and the speed in removing organic substances can be increased, accordingly.

The light having a wave number of larger than the work function of the catalyst may be emitted from a Xe₂ excimer lamp with a peak at a wave number of 5.81×10⁴ cm⁻¹ or a Kr₂ excimer lamp with a peak at a wave number of 6.85×10⁴ cm⁻¹. Since these excimer lamps can efficiently emit monochromatic light with a peak at those wave numbers, the organic substances can be removed without irradiating the object with excessive light or overheating the object with the excimer light. Also, since the dielectric barrier discharge lamp does not consume metal electrodes, the object is advantageously prevented from being contaminated.

The catalyst may be Pt, Rh, Pd, Ir, Ru, Re, or Au. In general, the catalyst is contaminated to wear away with a gas containing oxygen atoms generated from the object in some cases. By using a catalyst unreactive to oxygen, such as Pt, Rh, Pd, Ir, Ru, Re, or Au, the catalyst can be prevented from wearing away and the object can also be prevented from being contaminated.

The cracked product gas, such as activated O or H, may be delivered to the object effectively by jetting. Thus, the efficiency in using activated O or H can be increased, and consequently the organic substances can be removed at a high speed. In particular, if the object is placed in a normal atmosphere (in normal air) so as to be easily moved, continuous treatment can be performed by jetting.

The treatment apparatus may have irradiation unit for irradiating both the catalyst and the object with the light having a wave number of more than 6.67×10⁴ cm⁻¹ as light of more than work function expressed in wave number of the catalyst, wherein a molecular gas contains hydrogen atoms. Since the wave number of the light to be irradiate o the object is 6.67×10⁴ cm⁻¹, which accords with the absorption edge in the short wavelength region of SiO₂, the light is absorbed into SiO₂ and decompose the SiO₂ into Si+SiO. The Si⁺ SiO are attacked by activated H produced by the catalytic reaction. Thus, the SiO₂, which is difficult to etch by H alone, can be advantageously etched.

The light having a wave number of more than the work function expressed by wave number of the catalyst may be Kr₂ excimer light with a peak at a wave number of 6.85×10⁴ cm⁻¹ or Ar₂ excimer light with a peak at a wave number of 7.934×10⁴ cm⁻¹. In order to generate light having these wave numbers, a dielectric barrier discharge lamp can be used. Since the absorption edge in the short wavelength region of SiO₂ lies at 6.67×10⁴ cm⁻¹, the Kr₂ excimer light with a peak at a wave number of 6.85×10⁴ cm⁻¹ or the Ar₂ excimer light with a peak at a wave number of 7.934×10⁴ cm⁻¹ is absorbed into SiO₂ to decompose it into Si⁺ SiO. The Si+SiO are attacked by activated H produced by the catalytic reaction. Thus, the SiO₂, which is difficult to etch by H alone, can be advantageously etched.

### BRIEF DESCRIPTION OF THE DRAWINGS

FIG. 1 is a schematic view of a treatment apparatus according to first to fourth embodiments of the present invention;

FIG. 2 is a schematic view of a treatment apparatus according to the fifth embodiment of the present invention;

FIG. 3 is a schematic view of a treatment apparatus according to a sixth embodiment of the present invention;

FIG. 4 is a schematic view of a treatment apparatus according to a seventh embodiment of the present invention;

FIG. 5 is a schematic view of a treatment apparatus according to an eighth embodiment of the present invention;

FIG. 6 is a schematic view of a treatment apparatus according to a ninth embodiment of the present invention;

FIG. 7 is a schematic view of a treatment apparatus according to a tenth embodiment of the present invention; and

FIG. 8 is a schematic view of a known treatment apparatus.

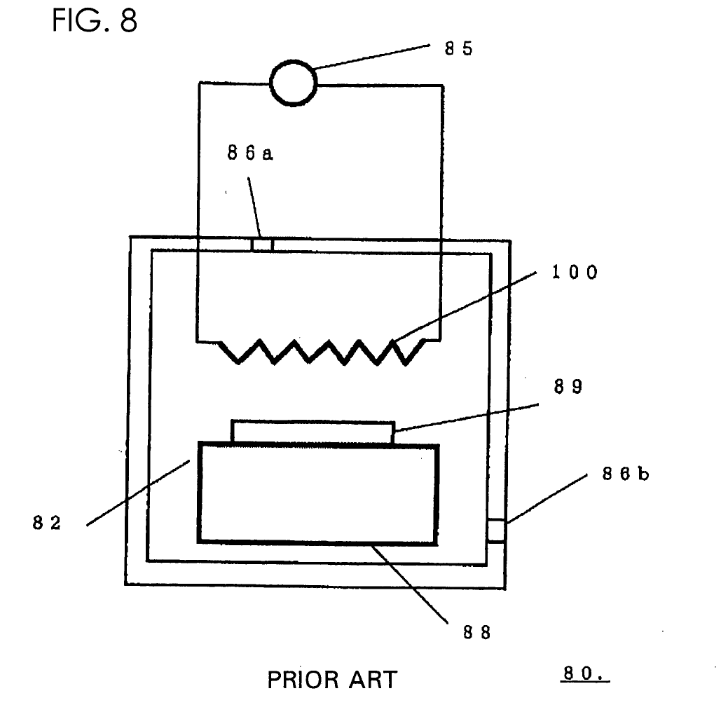

### DESCRIPTION OF THE PREFERRED EMBODIMENTS

In the treatment apparatus of the present invention, when a reactive gas containing oxygen atoms or hydrogen atoms adsorbs and dissociates on a high-melting-point metal catalyst and, thus, separates from the catalyst, light is emitted onto the catalyst to enable activated species to separate from the catalyst without heating the catalyst, or simply by supplemental heating. Also, by irradiating the reaction gas with the light, in addition to the catalyst, high-concentration activated species can be produced. Furthermore, if the object to be treated is irradiated with the light to activate its surface and to break the chemical bonds at the surface, the treatment speed can be increased. The embodiments of the present invention will now be described in detail.

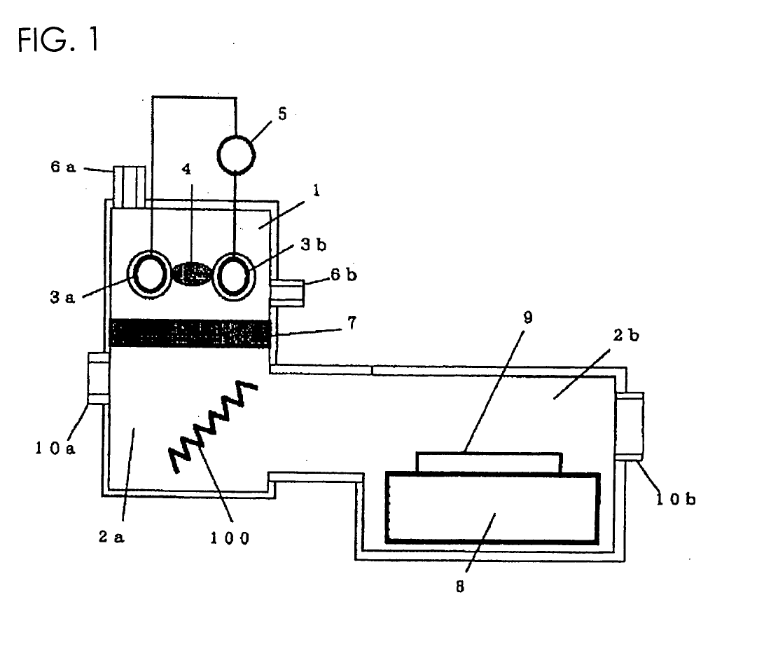

A treatment apparatus according to a first embodiment of the present invention is shown in FIG. 1, which is a schematic sectional view taken along a face perpendicular to the axes of cylindrical electrodes 3a and 3b. The treatment apparatus 11 includes a light emitting unit from which light having a wave number of more than 5.08×10⁴ cm⁻¹ is emitted The light emitting means includes a mechanism for emitting the light having such a wave number and a mechanism for transmitting the light. The light emitting mechanism includes a discharge container 1 as the mechanism for emitting the light, electrodes 3a and 3b for dielectric barrier discharge, and a power source 5 for the discharge etc., and uses Xe, Kr, Ar, or other gas as discharge gas. In the present embodiment, Ar (emitting light having a wave number of 7.934×10⁴ cm⁻¹) is used, and a window 7 made of MgF₂ is used to extract transmitting light. The discharge gas for generating the light having a wave number of more than 5.08×10⁴ cm⁻¹, such as Xe, Kr, or Ar etc., is introduced through a discharge gas inlet 6a and let out from an outlet 6b. An activated species generation space 2a is separated from the discharge container 1 by the light extraction window 7, and a catalyst 100 made of a high-melting-point metal such as tungsten, is placed in the activated species generation space 2a. Other high-melting-point metals, such as molybdenum, may be used as the catalyst 100. The activated gas generation space 2a has a reactive gas inlet 10a through which a gas to be activated, for example, ammonia (NH₃), is introduced. The introduced NH₃ is delivered via the catalyst 100 into a treatment space 2b containing an object 9 to be treated and a stage 8. The NH₃ introduced through the gas inlet 10a adsorbs on the catalyst and dissociates, separates from the catalyst, and subsequently comes into collision with the object, and finally it is discharged from a gas outlet 10b. A heater may be built in the stage.

In the first embodiment, the light is generated under the conditions set forth below. The dielectric barrier discharge electrodes 3a and 3b, which are illustrated by circles in the figure, are of cylinders, each of which includes a quartz glass tube having an outer diameter of 20 mm, a thickness of 1 mm, and a length of 250 mm, and aluminium is inserted inside the quartz glass tube. A distance between electrodes is 6 mm. Discharge gas is Ar and a pressure thereof is 6.65 MPa, and a power thereof is 200 W. Thus, discharge plasma 4 emits Ar₂ excimer light having a wave number of 7.934×10⁴ cm⁻¹ and the light is emitted to the catalyst 100 disposed in the activated species generation space 2a through the light extraction window 7.

In the present embodiment, a reaction is shown, wherein ammonia (NH₃) gas is introduced. The NH₃ introduced through the inlet 10a comes into collision with a tungsten wire, which is the catalyst 100, and adsorbs and dissociate on the surface of the tungsten (W), so that the introduced NH₃ is dissociated, thereby forming W—H on the surface of the tungsten. As for the N atoms of the NH₃, some of the N atoms react with the surface of the tungsten, so as to produce reacting substance but, probably, many of the N atoms are formed into nitrogen gas (N₂) by collision with each other and are thus suspended in the air. The W—H formed on the surface of tungsten 100 which is the catalyst is irradiated to the catalyst with the light having a wave number of 7.934×10⁴ cm⁻¹, so that the bond of W—H is broken to separate H from the surface of the tungsten. In the present embodiment, the catalyst is irradiated, and further supplementally heated by, for example, energization so that the separation of H from the catalyst is promoted. After separation of hydrogen atoms, on the surface of the tungsten, clean face is formed. The clean tungsten surface is subjected to collision of hydrogen molecules to repeat the same reaction. Thus, high-concentration activated H is produced in the activated species generation space 2a. The activated H is delivered into the treatment space 2b along with the stream of the NH₃ introduced through the inlet 10a or the stream of exhaust gas etc. forced to let out from the outlet 10b. The treatment space 2b contains an object to be treated, and the object is brought into contact with the high-concentration activated H produced in the activated species generation space 2a. The object has been contaminated with, for example, organic substances. The activated H reacts with the carbon and the oxygen in the organic substances, for example, CH₄ and H₂O, thus removing the organic substances from the object. In an example of the present embodiment, the catalyst 100 is made from tungsten wires, each of which has a 0.6 mm diameter, and the wires are arranged in a pitch of 15 mm. The object 9 was a glass substrate for a liquid crystal display, and the activated species produced from the NH₃ in the treatment space 2b has a pressure of 1 Pa. In this structure, the catalyst tungsten was irradiated with the light and simultaneously heated to 1,550° C. supplementally by energization. As a result, the glass substrate would be cleaned by about 25 second treatment.

Description of other embodiments in which the treatment apparatus shown in FIG. 1 uses other gases as the gas introduced for producing activated species or other materials as the catalyst. For example, the molecular gas containing hydrogen atoms may be methane (CH₄) or hydrogen (H₂) in place of ammonia (NH₃). The catalyst 100 may be molybdenum (Mo) instead of tungsten (W). Molybdenum can produce the same effect.

In a second embodiment, H₂ is used as the molecular gas, and Mo is used as the catalyst 100. By bringing H₂ into collision with Mo, the H₂ is adsorbed and dissociated so that Mo—H is formed on the surface of the Mo. The Mo—H is irradiated with light so that the Mo—H bond is easily broken to separate H from the surface of the Mo. In this instance, the light has a wave number of more than 5.08×10⁴ cm⁻¹ so as to easily separate the H from the surface of the catalyst 100. This is because such light has sufficiently higher energy than the work function of the Mo (3.35×10⁴ cm⁻¹). In addition, the Mo may be supplementally heated by energization to efficiently separate H from the surface of the catalyst 100.

In a third embodiment, the treatment apparatus shown in FIG. 1 uses a molecular gas containing oxygen atoms as the molecular gas introduced in order to produce activated species. Exemplary molecular gases containing oxygen atoms include oxygen (O₂), carbon monoxide (CO), carbon dioxide (CO₂), and nitrous oxide (N₂O) etc. In case of using these molecular gases, oxidation-resistant materials are suitably used as the catalyst, rather than the above-described metals, such as W and Mo. Such oxidation-resistant materials include platinum (Pt), rhodium (Rh), palladium (Pd), iridium (Ir), ruthenium (Ru), rhenium (Re), and gold (Au). For example, if in the third embodiment, Ir is used as the catalyst 100, and N₂O is used as the molecular gas for producing activated species, the N₂O comes into collision with the Ir and adsorption and dissociation take place in the same manner as in the case of W. This reaction provides products, such as Ir—O and Ir—ON etc. on the surface of the Ir. The products are irradiated with the light having a wave number of more than 5.08×10⁴ cm⁻¹, so that O is separated from the surface of the Ir. In addition to the irradiation, the catalyst Ir may be heated by energization to efficiently separate O from the Ir surface. The activated O separated from the Ir surface is brought into contact with the object, for example, a liquid crystal substrate, placed in the treatment space 2b, thus removing organic substances from the object by oxidation.

In a fourth embodiment, Pt, which has a relatively high work function (4.29×10⁴ cm⁻¹) among the above-mentioned oxidation-resistant metals, is used as the catalyst 100. If CO₂ is used as the molecular gas for producing the activated species, the CO₂ comes into collision with the Pt so that absorption and dissociation are take place, and products, such as Pt—O and Pt—C, are produced on the surface of the Pt. The products are irradiated with the light having a wave number of more than 5.08×10⁴ cm⁻¹ to separate activated O and C from the Pt surface. At this point, the Pt may be heated to efficiently separate the activated O and C from the Pt surface. The separated O and C can recombine with each other to be suspended in the air. Other activated O is delivered into the treatment space 2b and brought into contact with the object, for example, a liquid crystal substrate, placed in the treatment space 2b, thus removing organic substances from the object by oxidation. The light may be applied to the introduced molecular gas CO₂ and the separated activated O in addition to the catalyst 100, thereby producing ozone or activated O atoms having higher energy levels. Also, by irradiating the CO₂, part of the CO₂ can be directly dissociated by the light but not by the catalyst 100. Consequently, a high-concentration activated species is produced and brought into contact with the object in the treatment space 2b, and thus high-speed treatment can be achieved.

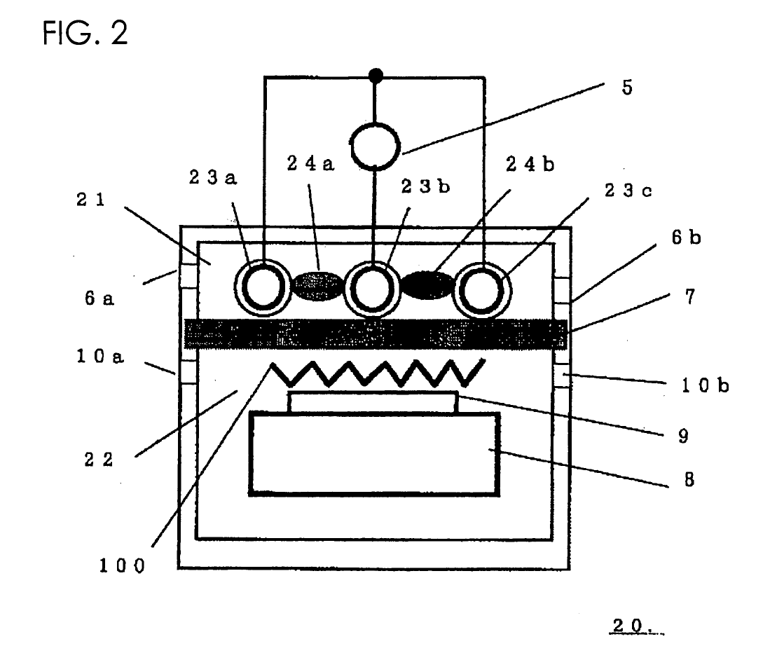

FIG. 2 shows a treatment apparatus according to a fifth embodiment of the present invention. In this apparatus, light is applied not only to the catalyst 100 and the molecular gas, but also to the object to be treated. FIG. 2 is a schematic sectional view taken along a face perpendicular to the axes of cylindrical electrodes 23a, 23b, and 23c. In order to apply the light having a wave number of more than 5.08×10⁴ cm⁻¹ to both the catalyst 100 and the object 9, the catalyst 100 and the object 9 are disposed directly under the light extraction window 7, in the treatment apparatus 20. For light emission, the apparatus 20 includes a discharge chamber 21, dielectric barrier discharge electrodes 23a, 23b, and 23c, and a discharge power source 5 etc., and a noble gas, such as Ar (emitting light having a wave number of 7.934×10⁴ cm⁻¹) is used as the discharge gas. The light extraction window 7 is made of MgF₂ to transmit the light. The discharge gas for generating the light having a wave number of more than 5.08×10⁴ cm⁻¹ is introduced through a discharge gas inlet 6a and let out from an outlet 6b. The object 9 is placed in a treatment space 22. Reference numeral 8 designates a stage which may contain a heater. A catalyst 100 made of a high-melting-point metal, which is tungsten, is disposed between the light extraction window 7 and the object 9. Reference numeral 10a designates an inlet through which the molecular gas, for example, NH₃, is introduced, and reference numeral 10b designates an outlet of the molecular gas.

In the fifth embodiment, the light is generated under conditions set forth below. The dielectric barrier discharge electrodes 23a, 23b, and 23c, which are illustrated by circles, are of cylinders, each of which includes a quartz glass tube having an outer diameter of 20 mm, a thickness of 1 mm, and a length of 250 mm, and aluminium is inserted inside the quartz glass tube. The electrodes are disposed at intervals of 6 mm. Discharge is performed with Ar having a pressure of 6.65 MPa, at a power of 200 W. Thus, discharge plasma 24a and 24b emits Ar₂ excimer light having a wave number of 7.934×10⁴ cm⁻¹ and the light is applied to the treatment space 22, the catalyst 100, and the object 9 through the light extraction window 7. In an example of the present embodiment, the catalyst 100 is made from tungsten wires having a 0.6 mm in diameter wherein a pitch thereof is 15 mm. The object 9 was a glass substrate for a liquid crystal display. The distance between the object 9 and the light extraction window 7 was set at 150 mm, the distance between the catalyst 100 and the object 9 is set to 100 mm. The pressure of the treatment space 22 containing NH₃ gas is 1 Pa. The tungsten was irradiated with the light and further heated supplementally to 1,550° C. The glass substrate for the liquid crystal display was cleaned by the treatment for about 25 seconds.

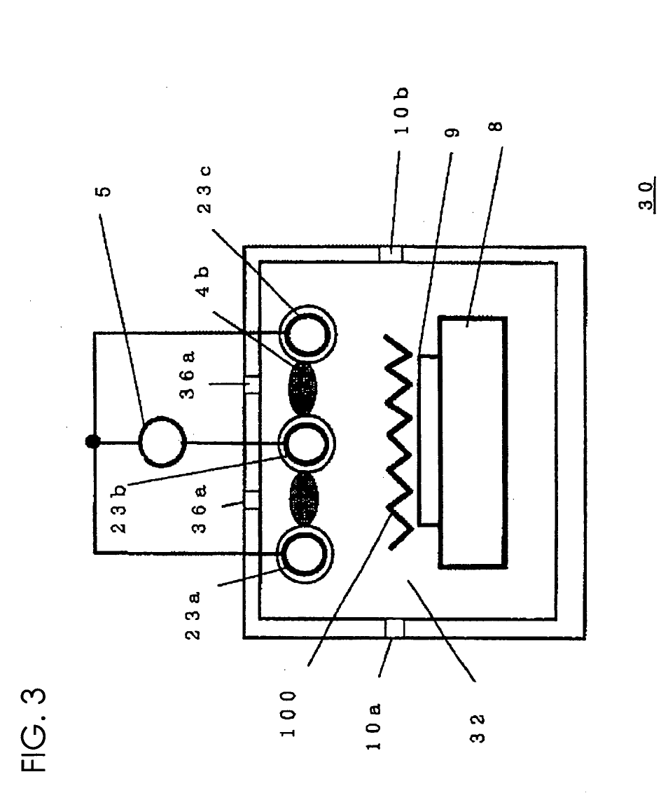

In the following sixth to eleventh embodiments, the object, as well as the catalyst 100 and the molecular gas, is irradiated with light. FIG. 3 is a sectional view of a treatment apparatus according to a sixth embodiment, taken along a face perpendicular to the axes of the cylindrical electrodes 23a, 23b, and 23c. In the sixth embodiment, the light extraction window 7 used in the fifth embodiment shown in FIG. 2 is taken away. Specifically, in the treatment apparatus 30 of the sixth embodiment, the discharge chamber 21 shown in FIG. 2 is shared with the treatment space 22. In the treatment space 32 of the apparatus 30 according to the present embodiment, the dielectric barrier discharge electrodes 23a, 23b, and 23c, an object 9 put on a stage 8, and the catalyst are 100 disposed between the electrodes 23a, 23b, and 23c and the object 9. In the treatment space 32, a molecular gas inlet 10a through which NH₃ or reactive molecular gas for treating the object 9 is introduced, an outlet 10b from which the molecular gas is discharged, and a discharge gas inlet 36a through which a discharge gas for generating light, such as Ar, is introduced. The discharge gas for light emission is introduced through the discharge gas inlet 36a and the molecular gas NH₃ is introduced to the vicinity of the surface of the object 9 through the molecular gas inlet 10a. The NH₃ may be diluted with nitrogen or argon gas. Gases produced by decomposing the NH₃, the discharge gas, and organic substances are discharged from the outlet 10b. The present embodiment can eliminate absorption loss resulting form the presence of the light extraction window 7, and consequently excimer light can be efficiently used.

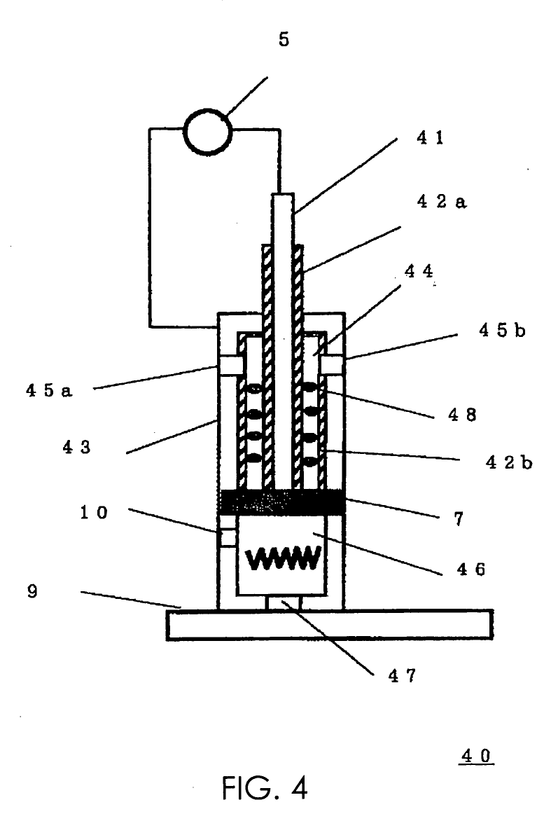

A seventh embodiment of the present invention is shown in FIG. 4, which is a schematic sectional view of a treatment apparatus, taken so as to expose the thickness of a first electrode 41 made of a rectangular metal plate, that is, taken along a face perpendicular to the lateral direction of the electrode. The treatment apparatus 40 of the present embodiment includes a first electrode 41 made of a rectangular metal plate and a second electrode 43 which is also used as a discharge chamber, and dielectric barrier discharge is performed between the first electrode 41 and the second electrode 43 to generate Ar₂ excimer light having a wave number of 7.934×10⁴ cm⁻¹. Specifically, the first electrode 41 is made of a SUS plate of 1 mm in thickness by 100 mm in height by 11,000 mm in width, and is covered with alumina 42a with a thickness of 0.5 mm, and the internal wall of the second electrode 43 is also covered with alumina 42b with a thickness of 0.5 mm. The electrodes are disposed at intervals of 3 mm. Ar is introduced through a discharge gas inlet 45a and discharged from a discharge gas outlet 45b. The pressure of the Ar is set at 4.65 MPa in the discharge chamber 44. The apparatus 40 also has an activated species generation space 46 separated by the light extraction window 7, and tungsten wire of 0.6 mm in diameter with a pitch of 15 mm is disposed as the catalyst 100 in the activated species generation space 46. The activated species generation space 46 has an inlet 10a through which NH₃ is introduced and an activated species jet 47 from which activated species produced in the presence of the catalyst 100 is jetted.

In the present embodiment, high-frequency power is applied between the first electrode 41 and the second electrode 43 from the discharge power source 5 to generate discharge plasma 48, thereby generating Ar₂ excimer light. By applying the Ar₂ excimer light onto the catalyst 100 through the light extraction window 7, activated species cracked on the catalyst 100 can be easily separated from the catalyst 100. For example, NH, H, and the like are produced from the NH₃ as the separated activated species. The activated species, such as NH and H, are jetted onto the object 9 from the activated species jet 47 of 1 mm by 1,000 mm. In the present embodiment, by shifting the object 9 or the treatment apparatus 40, the entire surface of the object 9 can be easily treated even if the object 9 has a large area.

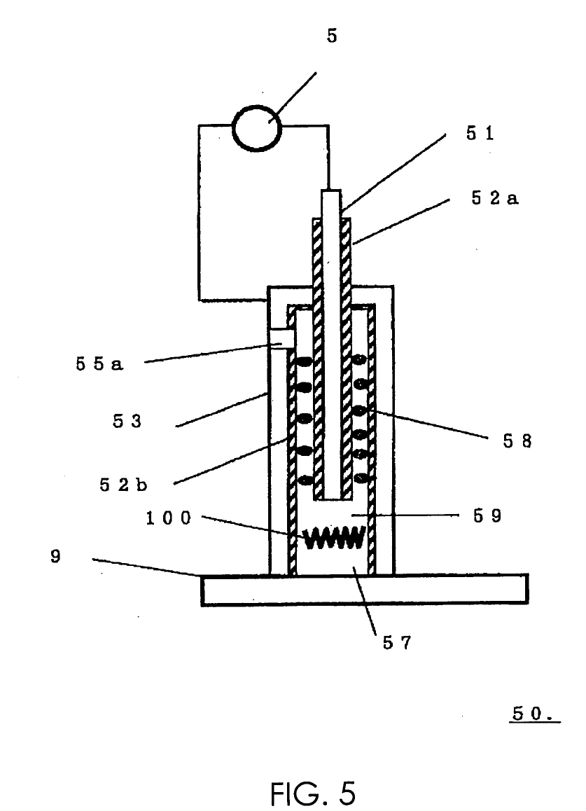

An eighth embodiment is shown in FIG. 5, which is a schematic sectional view of a treatment apparatus, taken in the same manner as in FIG. 4 showing the seventh embodiment so as to expose the thickness of a first electrode 51 made of a rectangular metal plate that is, taken perpendicular to the lateral direction of the electrode. In the eighth embodiment, the light extraction window 7 used in the seventh embodiment is taken away, and a treatment space 59 is provided wherein the discharge chamber 48 of the seventh embodiment is shared with the activated species generation space 46. Specifically, the treatment apparatus 50 of the present embodiment includes a first electrode 51 made from a rectangular metal plate, and a second electrode 53 doubling as a discharge chamber and a treatment space, in which dielectric barrier discharge is performed between the first electrode 51 and the second electrode 53 to generate Ar₂ excimer light having a wave number of 7.934×10⁴ cm⁻¹. Specifically, the first electrode 51 is made from a SUS plate of 1 mm in thickness by 100 mm in height by 11,000 mm in width, and is covered with alumina 52a with a thickness of 0.5 mm, and the internal wall of the second electrode 53 is also covered with alumina 52b with a thickness of 0.5 mm. The electrodes are disposed at intervals of 1 mm. Ar gas containing 10% of hydrogen is introduced through a discharge gas inlet 55a. In the treatment space 59 defined by the second electrode 53, functioning as a discharge chamber and a treatment space, tungsten wire of 0.6 mm in diameter with a pitch of 15 mm is disposed to serve as the catalyst 100. The treatment space 59 has an activated species jet 57 for jetting the activated species produced in the treatment space 59 to the object.

In the present embodiment, high-frequency power is applied between the first electrode 51 and the second electrode 53 from the discharge power source 5 to generate discharge plasma 58, thereby generating Ar₂ excimer light. In addition, the discharge plasma 58 and the Ar₂ excimer light directly act on the hydrogen contained in the discharge gas to partially change the hydrogen molecules into activated H. Furthermore, the hydrogen molecules are adsorbed and dissociated on the catalyst to crack into H. By applying the Ar₂ excimer light onto the catalyst 100, the separation of the activated H is promoted to produce high-concentration activated H. The resulting activated H is jetted onto the object 9 from the activated species jet 57 of 1 mm by 1,000 mm. In the present embodiment, by shifting the object 9 or the treatment apparatus 50, the entire surface of the object 9 can be easily treated even if the object 9 has a large area and high-speed treatment can be achieved.

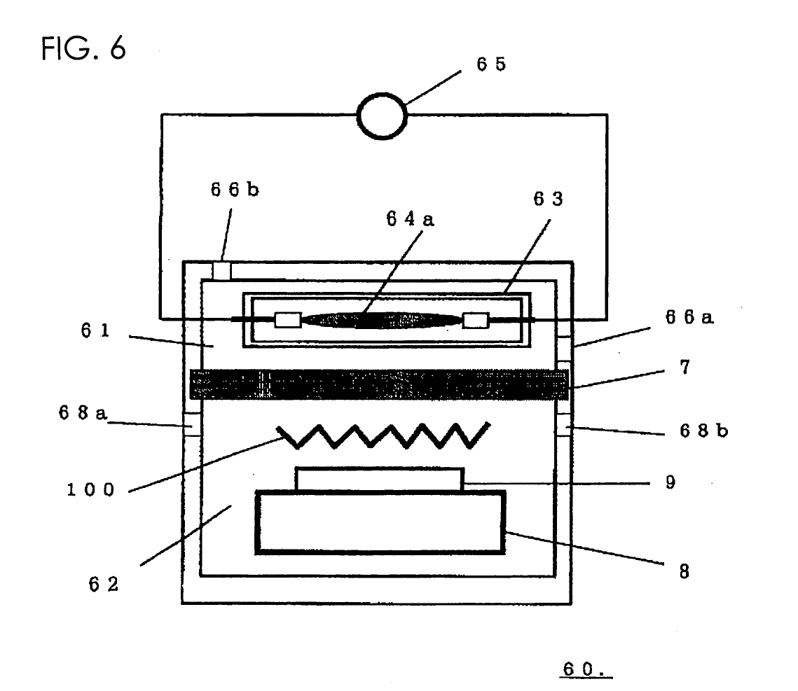

FIG. 6 shows a treatment apparatus according to a ninth embodiment of the present invention wherein a low-pressure mercury lamp is used as a light emitting unit for emitting light having a wave number of more than 5.08×10⁴ cm⁻¹ in a similar structure to the fifth embodiment. FIG. 6 is a schematic sectional view of the treatment apparatus taken along a face parallel to the axis of the low-pressure mercury lamp tube. Specifically, the treatment apparatus 60 in FIG. 6 includes a lamp house 61 in which the light having a wave number of 5.08×10⁴ cm⁻¹ is generated, a treatment space 62, and a light extraction window 7 separating the lamp house and the treatment space. The low-pressure mercury lamp 63 is disposed in the lamp house 61, and a discharge voltage is applied to the low-pressure mercury lamp 63 from an AC power supply 65, thereby generating discharge plasma 64a inside the low-pressure mercury lamp 63. The lamp house 61 has a gas inlet 66a through which a gas, such as N₂, is introduced and a gas outlet 66b from which the gas is discharged. The treatment space 62 has an inlet 68a through which a reactive gas is delivered to the object 9 put on a stage 8, and an outlet 68b from which the gas is discharged, as in the second embodiment. The catalyst 100 is disposed between the object 9 and the light extraction window 7.

In the present embodiment, the light applied onto the catalyst 100 and the object 9 has a wave number of 5.43×10⁴ cm⁻¹ corresponding to the emission line spectrum of mercury. Other conditions, such as the distances form the object 9 and the temperature of tungsten serving as the catalyst 100, are the same as in the fifth embodiment. In an example of the present embodiment, a glass substrate for liquid crystal display was used as the object 9 and treated as in the fifth embodiment. As a result, the glass substrate was cleaned by treating it for about 45 seconds.

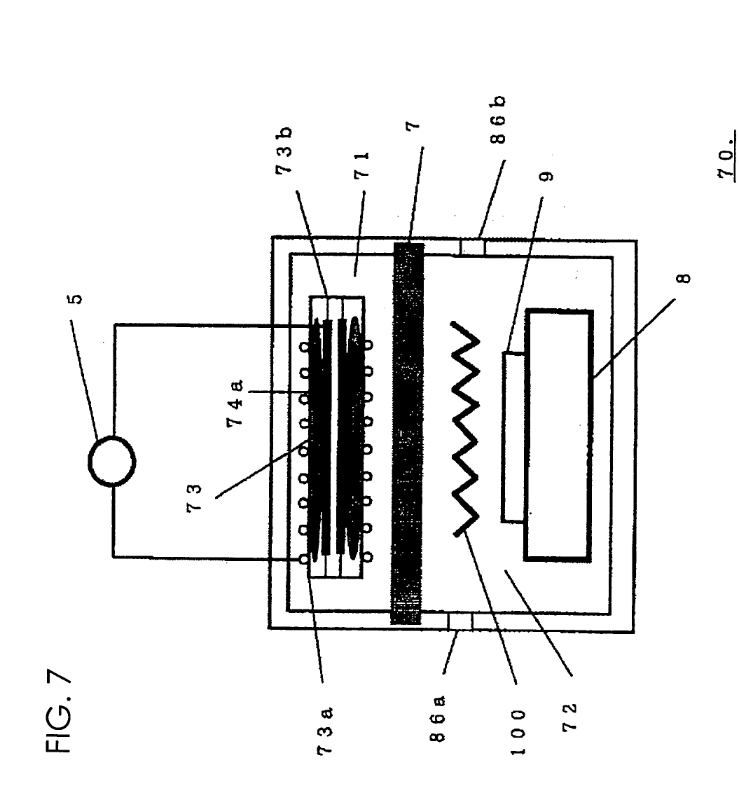

FIG. 7 shows a treatment apparatus according to a tenth embodiment of the present invention. In the treatment apparatus 70 of the present embodiment, a Xe₂ excimer lamp 73 is used as a light source emitting light having a wave number of more than 5.08×10⁴ cm⁻¹, instead of the low-pressure mercury lamp 63 shown in FIG. 6 used in the ninth embodiment, and is placed in a lamp house 71. In the Xe₂ excimer lamp 73, and an external tube 73a with an outer diameter of 26 mm and a thickness of 1 mm, an internal tube 73b with an outer diameter of 16 mm and a thickness of 1 mm are concentrically disposed in the external tube 73b, and Xe gas is enclosed at a pressure of 5.32 MPa between the external tube 73a and the internal tube 73b. The discharge power is set at 200 W. The discharge plasma 74a from the Xe₂ excimer lamp 73 emits Xe₂ excimer light having a wave number of 5.81×10⁴ cm⁻¹, and the light is applied to a treatment space 72, and onto the catalyst 100 and the object 9 through the light extraction window 7. The lamp house 71 is purged with N₂ gas by introducing nitrogen from a nitrogen gas inlet 76a therein. The nitrogen gas is discharged from an outlet 76b. In an example of the present embodiment, quartz glass was used as the object 9 and disposed 200 mm distant between the light extraction window 7 and the object 9. Tungsten was used as the catalyst 100 and disposed at 150 mm distant between the object and catalyst. The temperature of the object 9 was set at 25° C. Hydrogen was introduced to the treatment space 72 and the pressure of the hydrogen molecules was set at 66.5 Pa. Thus, organic substances on the quarts glass or object 9 were treated. As a result, the organic substances on the quarts glass were removed by treating for about 20 seconds. Also, instead of the Xe₂ excimer lamp 73, excimer lamps filled with Kr₂ or Ar₂ were used as the light source. As a result, any of the lamps emitted high-energy light having a wave number of more than 5.08×10⁴ cm⁻¹, and accordingly the same effect as in use of the Xe₂ excimer lamp 73 was produced.

In an eleventh embodiment according to the present invention, SiO₂ is etched. The treatment apparatus of the eleventh embodiment has the same structure as in FIG. 2. In the present embodiment, a Si wafer is used as the object 9 to be treated. The surface of the Si wafer is formed with a SiO₂ film of about 2 nm in thickness. NH₃ is introduced into the treatment space 22, and the pressure of the NH₃ is set at about 1 Pa. The NH₃ adsorbs and dissociates on the catalyst 100, and is efficiently separated from the catalyst by applying the Ar₂ excimer light, thus producing activated HN and H. Also, the Ar₂ excimer light is directly applied onto the SiO₂ film from the discharge container 1, thereby breaking the bonds of SiO₂. The broken bonds react with the activated species produced in the presence of the catalyst 100 to etch the SiO₂. In an example of the present embodiment, the treatment was performed for about 900 seconds. As a result, the SiO₂ film was etched to a depth of 2 nm. It suffices that the light applied onto the SiO₂ film has a wave number of 6.67×10⁴ cm⁻¹ or more. For example, even Kr₂ excimer light with a peak at a wave number of 6.85×10⁴ cm⁻¹ which corresponds to the absorption end of a short wave side of SiO₂ produces the same effect as Ar₂ excimer light with a peak at a wave number of 7.934×10⁴ cm⁻¹.

Thus the present invention possesses a number of advantages or purposes, and there is no requirement that every claim directed to that invention be limited to encompass all of them.

The disclosure of Japanese Patent Application No. 2004-043391 filed on Feb. 19, 2004 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A treatment apparatus in which catalyst is used in order to dissolve molecular gas containing hydrogen atoms or oxygen atoms, and an object is treated by gas produced by the catalyst, comprising a catalyst irradiation unit, wherein the catalyst is irradiated, by the catalyst irradiation unit, with light having a wave number larger than work function of the catalyst expressed in wave number.

2. The treatment apparatus according to claim 1, further including an object irradiation unit, wherein a object is irradiated, by the object irradiation unit, with light having a wave number larger than work function of the catalyst expressed in wave number.

3. The treatment apparatus according to claim 1, wherein the wave number of the light is larger than 5.08×10⁴ cm⁻¹.

4. The treatment apparatus according to claim 2, wherein the wave number of the light is larger than 5.08×10⁴ cm⁻¹.

5. The treatment apparatus according to claim 1, wherein the light is Ar₂ excimer light with a peak at a wave number of 7.934×10⁴ cm⁻¹.

6. The treatment apparatus according to claim 2, wherein the light is Ar₂ excimer light with a peak at a wave number of 7.934×10⁴ cm⁻¹.

7. The treatment apparatus according to claim 3, wherein the light is Ar₂ excimer light with a peak at a wave number of 7.934×10⁴ cm⁻¹.

8. The treatment apparatus according to claim 4, wherein the light is Ar₂ excimer light with a peak at a wave number of 7.934×10⁴ cm⁻¹.

9. The treatment apparatus according to claim 5, wherein the Ar₂ excimer light from the catalyst irradiation unit or the object irradiation unit is emitted by dielectric barrier discharge in Ar discharge gas, and the discharge gas contains hydrogen atoms or oxygen atoms.

10. The treatment apparatus according to claim 6, wherein the Ar₂ excimer light from the catalyst irradiation unit or the object irradiation unit is emitted by dielectric barrier discharge in Ar discharge gas, and the discharge gas contains hydrogen atoms or oxygen atoms.

11. The treatment apparatus according to claim 7, wherein the Ar₂ excimer light from the catalyst irradiation unit or the object irradiation unit is emitted by dielectric barrier discharge in Ar discharge gas, and the discharge gas contains hydrogen atoms or oxygen atoms.

12. The treatment apparatus according to claim 8, wherein the Ar₂ excimer light from the catalyst irradiation unit or the object irradiation unit is emitted by dielectric barrier discharge in Ar discharge gas, and the discharge gas contains hydrogen atoms or oxygen atoms.

13. The treatment apparatus according to claim 1, wherein the catalyst irradiation unit is a Xe₂ excimer lamp with a peak at wave number of 5.81×10⁴ cm⁻¹ or a Kr₂ excimer lamp with a peak at a wave number of 6.85×10⁴ cm⁻¹.

14. The treatment apparatus according to claim 1, wherein the object irradiation unit is a Xe₂ excimer lamp with a peak at wave number of 5.81×10⁴ cm⁻¹ or a Kr₂ excimer lamp with a peak at a wave number of 6.85×10⁴ cm⁻¹.

15. The treatment apparatus according to claim 1, wherein the catalyst is at least one member selected from a group consisting of Pt, Rh, Pd, Ir, Ru, Re, and Au.

16. The treatment apparatus according to claim 1, wherein dissociation gas is jetted onto the object.

17. A treatment apparatus in which catalyst is used in order to dissolve molecular gas containing hydrogen atoms, and an object is treated by gas produced by the catalyst, comprising: a light emitting unit, that irradiates the catalyst and the object with light having a wave number of larger than work function of the catalyst expressed in wave number, and the light has a wave number of 6.67×10⁴ cm⁻¹ or more.

18. The treatment apparatus according to claim 10, wherein the light is used in order to carry out etching to SiO₂.

19. The treatment apparatus according to claim 9′, wherein the light is a Kr₂ excimer light with a peak at a wave number of 6.85×10⁴ cm⁻¹ or a Ar₂ excimer light with a peak at wave number of 7.934×10⁴ cm⁻¹.
